(19) United States
(12) Patent Application Publication
(10) Pub. No.: US 2026/0291363 A1
(43) Pub. Date: Sep. 24, 2026

(54) CIRCUIT WITH DYNAMIC BIASING AND INPUT COMPENSATION

(71) Applicant: TEXAS INSTRUMENTS INCORPORATED, Dallas, TX (US)

(72) Inventors: Ricardo NUNES, Freising (DE); Ali FERSCHISCHI, Freising (DE)

(21) Appl. No.: 19/085,300

(22) Filed: Mar. 20, 2025

(51) Int. Cl. H02M 1/00; B60L 53/22; H02M 1/14

(52) U.S. Cl. CPC H02M 1/0035; B60L 53/22; H02M 1/143; B60L 2210/30

(57) ABSTRACT

A system includes: a load; a circuit having switches, the circuit coupled to the load; and a controller coupled to the circuit. The controller is configurable to: receive a first current at a third terminal of a comparator; receive a second current at the third terminal of the comparator responsive to entering a pause mode in which the switches are turned off, the second current less than the first current; receive a first signal at a first terminal of the comparator during the pause mode; apply a compensation to the first signal resulting in a compensated first signal; receive a second signal at a second terminal of the comparator; provide comparison results at a fourth terminal of the comparator responsive to the compensated first signal and the second signal; and provide control signals for the switches responsive to the comparison results.

### BACKGROUND

Switching converters are used to provide a direct-current (DC) output voltage (VOUT) based on an input voltage (VIN). A typical switching converter includes: a power stage with switches and an inductor; and a controller for the switches of the power stage. The controller includes a control loop with a comparator. To reduce power consumption, the comparator uses dynamic biasing (e.g., use of different quiescent currents). For example, when the controller directs the switches in a continuous current mode (CCM), the comparator receives a first quiescent current. When the controller is in pause mode (e.g., part of a low-power mode with switching intervals separated by pause intervals), the comparator receives a second quiescent current that is lower than the first quiescent current. Dynamic biasing of the comparator results in some voltage variance at an input terminal of the comparator. Such voltage variance at an input terminal of the comparator affects the control loop and results in switching bursts (overlapping switching cycles without a pause interval). Such switching bursts undesirably increase output voltage ripple.

### SUMMARY

In an example, system includes: a load; a circuit having switches, the circuit coupled to the load; and a controller coupled to the circuit. The controller is configurable to: receive a first current at a third terminal of a comparator; receive a second current at the third terminal of the comparator responsive to entering a pause mode in which the switches are turned off, the second current less than the first current; receive a first signal at a first terminal of the comparator during the pause mode; apply a compensation to the first signal resulting in a compensated first signal, the compensated first signal having a lower amplitude than the first signal; receive a second signal at a second terminal of the comparator; provide comparison results at a fourth terminal of the comparator responsive to the compensated first signal and the second signal; and provide control signals for the switches responsive to the comparison results.

In another example, a circuit includes: a first transistor; a second transistor; dynamic biasing circuitry; and a compensation circuit. The first transistor has a first terminal, a second terminal, and a control terminal. The second transistor has a first terminal, a second terminal, and a control terminal. The first and second transistors form an input pair. The dynamic biasing circuitry includes a third transistor having a first terminal, a second terminal, and a control terminal. The second terminal of the third transistor is coupled to the first terminals of the first transistor and the second transistor. The compensation circuitry is coupled to the control terminal of the first transistor. The compensation circuitry is configurable to apply a compensation to a signal at the control terminal of the first transistor. The compensation reduces an amplitude of the signal.

In yet another example, a circuit includes: an error amplifier; a comparator; dynamic biasing circuitry; and compensation circuitry. The error amplifier has a first terminal, a second terminal, and a third terminal. The comparator has a first terminal, a second terminal, a third terminal, and a fourth terminal. The second terminal of the comparator is coupled to the third terminal of the error amplifier. The dynamic biasing circuitry is coupled to the third terminal of the comparator. The compensation circuitry is coupled to the first terminal of the comparator and is configurable to apply a compensation to a signal at the first terminal of the comparator.

### BRIEF DESCRIPTION OF THE DRAWINGS

FIG. 1 is a diagram showing an example vehicle.

FIG. 2 is a diagram showing an example computer rack.

FIG. 3 is a diagram showing an example controller.

FIG. 4 is a diagram showing another example controller.

FIG. 5 is a diagram showing example controller circuitry.

FIG. 6 is a timing diagram showing example waveforms of a controller.

FIG. 7 is a timing diagram showing example waveforms of a power stage and controller.

### DETAILED DESCRIPTION

The same reference numbers or other reference designators are used in the drawings to designate the same or similar features. Such features may be the same or similar either by function and/or structure.

Described herein are circuits with dynamic biasing and compensation circuitry. Example circuits include comparators, low-dropout regulator, or other circuits with input pair transistors. The compensation circuitry accounts for the effect of dynamic biasing on one or more input signals to the circuit. In some examples, the effect of dynamic biasing for the circuit is variance or disturbance to an input signal due to local capacitance in the circuit (e.g., gate-source capacitance of an input pair transistor of the circuit). The compensation circuitry operates to apply a compensation that reduces the disturbance or variance to the input signal, resulting in more accurate comparison results. In some examples, the disturbance or variance in the input signal due to dynamic biasing increases an amplitude of the input signal. In such examples, the compensation reduces the amplitude of the input signal to account for amplitude changes in the input signal due to dynamic biasing and local capacitance (e.g., the gate-source capacitance of an input pair transistor). In some examples, the circuit is a comparator that is part of a controller with a control loop, where improved comparator results result in improved control loop operations. In some examples, the controller provides control signals for switches of a switching converter based on the comparison results, where the improved accuracy of comparison results reduces output voltage (VOUT) ripple and improves efficiency of the switching converter.

In some examples, the switching converter and the controller are components of a battery-powered system, where improved efficiency of the switching converter and controller extend the battery charge. In other examples, the switching converter and the controller are components of a data storage system, where improved efficiency of the switching converter and controller reduces power consumption of the data storage system. In some examples, a battery-powered system (e.g., a vehicle) or a data storage system (e.g., a computer rack of a data storage center or artificial intelligence processing center) may include many switching converters and respective controllers, where the improvements in efficiency for each are cumulative.

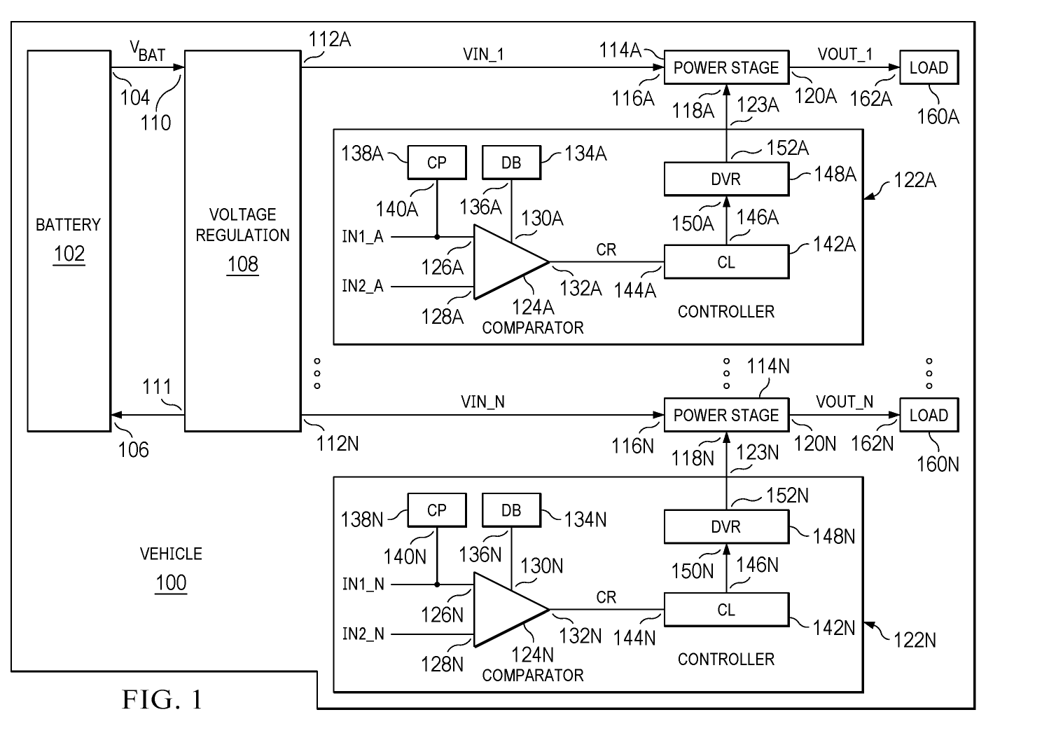

FIG. 1 is a diagram showing an example vehicle 100. The vehicle 100 may be a car or other vehicle. In the example of FIG. 1, the vehicle 100 includes a battery 102, voltage regulation circuitry 108, power stages 114A to 114N, controllers 122A to 122N, and loads 160A to 160N. The battery 102 has a first terminal 104 and a second terminal 106. The vehicle 100 may also include a battery charge controller (not shown) coupled to the first terminal 104 and the second terminal 106 of the battery 102 to regulate charging the battery 102 via external or internal power sources. The voltage regulation circuitry 108 has a first terminal 110, a second terminal 111, and a set of third terminals 112A to 112N. Each of the power stages 114A to 114N has a respective first terminal 116A to 116N, respective sets of second terminals 118A to 118N, and a respective third terminal 120A to 120N. Each of the controllers 122A to 122N has respective sets of terminals 123A to 123N. Each of the loads 160A to 160N has a respective terminal 162A to 162N.

In the example of FIG. 1, each of the controllers 122A to 122N includes a respective comparator 124A to 124N, respective dynamic biasing circuitry 134A to 134N, respective compensation circuitry 138A to 138N, respective control logic 142A to 142N, and respective driver circuitry 148A to 148N. Each of the comparators 124A to 124N has a respective first terminal 126A to 126N, a respective second terminal 128A to 128N, a respective third terminal 130A to 130N, and a respective fourth terminal 132A to 132N. Each dynamic biasing circuitry 134A to 134N has a respective terminal 136A to 136N. Each compensation circuitry 138A to 138N has a respective terminal 140A to 140N. Each control logic 142A to 142N has a respective first terminal 144A to 144N and respective sets of second terminals 146A to 146N. Each driver circuitry 148A to 148N has respective sets of first terminals 150A to 150N and respective sets of second terminals 152A to 152N.

The first terminal 104 of the battery 102 is coupled to the first terminal 110 of the voltage regulation circuitry 108. The second terminal 106 of the battery 102 is coupled to the second terminal 111 of the voltage regulation circuitry 108. Each terminal of the set of third terminals 112A to 112N of the voltage regulation circuitry 108 is coupled to a respective terminal of the first terminals 116A to 116N of the power stages 114A to 114N. Terminals of the sets of second terminals 118A to 118N of the power stages 114A to 114N are coupled to respective terminals of the sets of terminals 123A to 123N of the controllers 122A to 122N. Each terminal of the third terminals 120A to 120N of the power stages 114A to 114N is coupled to a respective terminal of the terminals 162A to 162N of the loads 160A to 160N.

The first terminal 126A of the comparator 124A is coupled to the terminal 140A of the compensation circuitry 138A and a first signal (IN1_A) source (not shown). The second terminal 128A of the comparator 124A is coupled to a second signal (IN2_A) source (not shown). The third terminal 130A of the comparator 124A is coupled to the terminal 136A of the dynamic biasing circuitry 134A. The fourth terminal 132A of the comparator 124A is coupled to the first terminal 144A of the control logic 142A. The set of second terminals 146A of the control logic 142A are coupled to respective terminals of the set of first terminals 150A of the driver circuitry 148A. The set of second terminals 152A of the driver circuitry 148A are coupled to respective terminals of the set of terminals 123A of the controller 122A. Each of the controllers 122B (not shown) to 122N has a similar topology up to the controller 122N. The first terminal 126N of the comparator 124N is coupled to the terminal 140N of the compensation circuitry 138N and a first signal (IN1_N) source (not shown). The second terminal 128N of the comparator 124N is coupled to a second signal (IN2_N) source (not shown). The third terminal 130N of the comparator 124N is coupled to the terminal 136N of the dynamic biasing circuitry 134N. The fourth terminal 132N of the comparator 124N is coupled to the first terminal 144N of the control logic 142N. The set of second terminals 146N of the control logic 142N are coupled to respective terminals of the set of first terminals 150N of the driver circuitry 148N. The set of second terminals 152N of the driver circuitry 148N are coupled to respective terminals of the set of terminals 123N of the controller 122N.

The battery 102 operates to provide a battery voltage (V_{BAT}) and current to the voltage regulation circuitry 108. In the example of FIG. 1, V_{BAT} is the voltage across the first and second terminals 104 and 106 of the battery 102 and across the first and second terminals 110 and 111 of the voltage regulation circuitry 108. The current draw from the battery 102 varies depending on the loads 160Ato 160Nand regulation of current by the each of the power stages 114A to 114N and respective controllers 122Ato 122N. Each of the controllers 122Ato 122Nsupports different modes for the power stages 114A to 114N including a continuous current mode (CCM) and a discontinuous current mode (DCM) (or low-power mode). During CCM operations, switches of a power stage have on/off intervals without pausing between the on/off intervals to support a target VOUT and output current for a continuous load. During DCM operations, switches of a power stage have on/off intervals with pauses between the on/off intervals to support a target VOUT and output current for a light load or sporadic load. During DCM operations or related pause intervals, each dynamic biasing circuitry 134Ato 134N is able to adjust the current provided to a respective comparator of the comparators 124Ato 124N. The current is provided, for example, via respective terminals 136A to 136N of the dynamic biasing circuitries 134Ato 134Nand respective terminals of the third terminals 130Ato 130N of the comparators 124Ato 124N. In some examples, during CCM operations, each dynamic biasing circuitry 134Ato 134Nprovides a first current to a respective comparator of the comparators 124Ato 124N. During DCM operations or related pause intervals, each dynamic biasing circuitry 134Ato 134Nprovides a second current to a respective comparator of the comparators 124Ato 124N, where the second current is less than the first current.

The compensation circuitry 138A to 138N applies a compensation to respective signals IN1_A to IN1_N to account for the effect of dynamic biasing. In some examples, the effect of dynamic biasing is variance in the signals IN1_A to IN1_N (e.g., an increase in voltage) due to local capacitance (e.g., gate-source capacitance of an input pair transistor of each respective comparator). In some examples, the compensation circuitry 138A reduces the variance of the signal IN1_A at the first terminal 126A of the comparator 124A, the compensation circuitry 138B reduces variance of the signal IN1_B at the first terminal 126B of the comparator 124B, and so on up to the compensation circuitry 138B reducing variance of the signal IN1_N at the first terminal 126N of the comparator 124N.

With the compensation circuitry 138A to 138N, input signal disturbance or variance is reduced and comparison results at the fourth terminals 132A to 132N of the comparators 124A to 124N are more accurate, resulting in improved control loop operations. Respective comparison results are provided to respective first terminals 144A to 144N of the control logic 142A to 142N. Each control logic 142A to 142N operates to generate respective switch control signals at respective terminals of the set of second terminals 146A to 146N responsive to the comparison results. Each driver circuitry 148A to 148N operates to receive respective switch control signals (at respective terminals of the set of first terminals 150A to 150N) and provides corresponding switch drive signals (at respective terminals of the set of second terminals 152A to 152N). The switch drive signals are output from respective terminals of the sets of terminals 123A to 123N of the controllers 122A to 122N and are provided to respective terminals of the sets of second terminals 118A to 118N of the power stages 114A to 114N to control respective switches of the power stages 114A to 114N. As each load 160A to 160N may vary, each controller 122A to 122N may control each respective power stage of the power stages 114A to 114N differently. With the compensation circuitry 138A to 138N, comparison results are adjusted such that switching bursts (overlapping switching cycles without a pause interval) are avoided during DCM operations.

In an example switching cycle, there is a ramp-up interval followed by a ramp-down interval. In a ramp-up interval, the high-side switch is on and the low-side switch off. In a ramp-down interval, the low-side switch is on and the high-side switch is off. A switching burst is when subsequent switching cycles overlap. In one example of a switching burst, subsequent ramp-up intervals occur without a ramp-down interval. In another example of a switching burst, subsequent ramp-up intervals occur without a full ramp-down interval between the subsequent ramp-up intervals. In another example of a switching burst, subsequent switching cycles occur without a pause interval between the subsequent switching cycles. During DCM, such switching bursts are undesirable and can occur due to control loop issues (e.g., if comparator input is affected by dynamic biasing of the comparator and no compensation is provided).

Use of the dynamic biasing circuitry 134A to 134N and the compensation circuitry 138A to 138N with respective comparators 124A to 124N reduces power consumption during respective DCM operations while avoiding switching bursts to reduce VOUT ripple and improve efficiency of the power stages 114A to 114N. The improved efficiency of the power stages 114A to 114N is cumulative, which provide benefits such as: reducing power consumption of the vehicle 100; extending the charge duration and life of the battery 102 of the vehicle; reducing unwanted heat emissions by electronics of the vehicle 100; and reducing heat sink / cooling overhead for electronics of the vehicle 100.

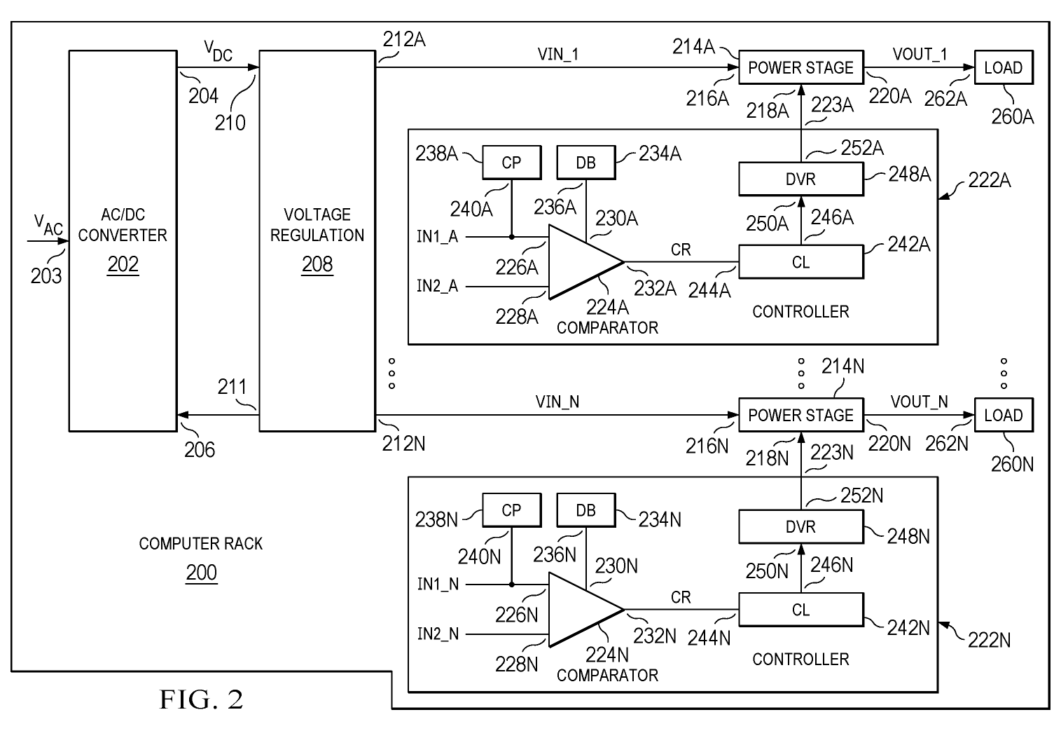

FIG. 2 is a diagram showing an example computer rack 200. The computer rack 200 may be part of a data storage center or artificial intelligence processing center. In the example of FIG. 2, the computer rack 200 includes an alternating-current to direct-current (AC/DC) converter 202, voltage regulation circuitry 208, power stages 214A to 214N, controllers 222A to 222N, and loads 260A to 260N. The AC/DC converter 202 has a first terminal 203, a second terminal 204, and a third terminal 206. The voltage regulation circuitry 208 has a first terminal 210, a second terminal 211, and a set of third terminals 212A to 212N. Each of the power stages 214A to 214N has a respective first terminal 216A to 216N, a respective set of second terminals 218A to 218N, and a respective third terminal 220A to 220N. Each of the controllers 222A to 222N has a respective set of terminals 223A to 223N. Each of the loads 260A to 260N has a respective terminal 262A to 262N.

In the example of FIG. 2, each of the controllers 222A to 222N includes a respective comparator 224A to 224N, respective dynamic biasing circuitry 234A to 234N, respective compensation circuitry 238A to 238N, respective control logic 242A to 242N, and respective driver circuitry 248A to 248N. Each of the comparators 224A to 224N has a respective first terminal 226A to 226N, a respective second terminal 228A to 228N, a respective third terminal 230A to 230N, and a respective fourth terminal 232A to 232N. Each dynamic biasing circuitry 234A to 234N has a respective terminal 236A to 236N. Each compensation circuitry 238A to 238N has a respective terminal 240A to 240N. Each control logic 242A to 242N has a respective first terminal 244A to 244N and a respective set of second terminals 246A to 246N. Each driver circuitry 248A to 248N has a respective set of first terminals 250A to 250N and a respective set of second terminals 252A to 252N.

The second terminal 204 of the AC/DC converter 202 is coupled to the first terminal 210 of the voltage regulation circuitry 208. The third terminal 206 of the AC/DC converter 202 is coupled to the second terminal 211 of the voltage regulation circuitry 208. Each terminal of the set of third terminals 212A to 212N of the voltage regulation circuitry 208 is coupled to a respective terminal of the first terminals 216A to 216N of the power stages 214A to 214N. Each terminal of the set of second terminals 218A to 218N of the power stages 214A to 214N is coupled to a respective terminal of the set of terminals 223A to 223N of the controllers 222A to 222N. Each terminal of the third terminals 220A to 220N of the power stages 214A to 214N is coupled to a respective terminal of the terminals 262A to 262N of the loads 260A to 260N.

The first terminal 226A of the comparator 224A is coupled to the terminal 240A of the compensation circuitry 238A and a first signal (IN1_A) source (not shown). The second terminal 228A of the comparator 224A is coupled to a second signal (IN2_A) source (not shown). The third terminal 230A of the comparator 224A is coupled to the terminal 236A of the dynamic biasing circuitry 234A. The fourth terminal 232A of the comparator 224A is coupled to the first terminal 244A of the control logic 242A. The set of second terminals 246A of the control logic 242A are coupled to respective terminals of the set of first terminals 250A of the driver circuitry 248A. The set of second terminals 252A of the driver circuitry 248A are coupled to respective terminals of the set of terminals 223A of the controller 222A. Each of the controllers 222B (not shown) to 222N has a similar topology up to the controller 222N. The first terminal 226N of the comparator 224N is coupled to the terminal 240N of the compensation circuitry 238N and a first signal (IN1_N) source (not shown). The second terminal 228N of the comparator 224N is coupled to a second signal (IN2_N) source (not shown). The third terminal 230N of the comparator 224N is coupled to the terminal 236N of the dynamic biasing circuitry 234N. The fourth terminal 232N of the comparator 224N is coupled to the first terminal 244N of the control logic 242N. The set of second terminals 246N of the control logic 242N are coupled to respective terminals of the set of first terminals 250N of the driver circuitry 248N. The set of second terminals 252N of the driver circuitry 248N are coupled to respective terminals of the set of terminals 223N of the controller 222N.

The AC/DC converter 202 operates to: receive an alternating-current voltage (V_{AC}) at the first terminal 203; and provide a direct-current voltage (V_{DC}) and current to the voltage regulation circuitry 108. In the example of FIG. 2, the voltage across the second and third terminals 204 and 206 of the AC/DC converter 202 is V_{DC}, which is the same voltage across the first and second terminals 210 and 211 of the voltage regulation circuitry 208. The current draw from the AC/DC converter 202 varies depending on the loads 260Ato 260N and regulation of current by the each of the power stages 214A to 214Nand respective controllers 222Ato 222N. Each of the controllers 222Ato 222Nsupports different modes for the power stages 214A to 214N including CCM and DCM. During DCM operations or related pause intervals, each dynamic biasing circuitry 234Ato 234Nis able to adjust the current provided to a respective comparator of the comparators 224Ato 224N. The current is provided, for example, via respective terminals 236A to 236Nof the dynamic biasing circuitry 234A to 234Nand respective terminals of the third terminals 230Ato 230N of the comparators 224A to 224N. In some examples, during CCM operations, each dynamic biasing circuitry 234Ato 234N provides a first current to a respective comparator of the comparators 224Ato 224N. During DCM operations or related pause intervals, each dynamic biasing circuitry 234A to 234Nprovides a second current to a respective comparator of the comparators 224A to 224N, where the second current is less than the first current.

The compensation circuitry 238A to 238N applies a compensation to respective signals IN1_A to IN1_N to account for the effect of dynamic biasing and local capacitance (e.g., the gate-source capacitance of an input pair transistor). In some examples, the effect of dynamic biasing is variance in the signals IN1_A to IN1_N (e.g., an increase in voltage) due to local capacitance (e.g., the gate-source capacitance of an input pair transistor of each respective comparator). In such examples, the compensation circuitry 238A compensates signal IN1_A at the first terminal 226A of the comparator 224A, the compensation circuitry 238B (represented but not shown) compensates signal IN1_B at the first terminal 226B (represented but not shown) of the comparator 224B (represented but not shown), and so on up to the compensation circuitry 238B compensating the signal IN1_N at the first terminal 226N of the comparator 224N.

With the compensation circuitry 238Ato 238N, comparison results at the fourth terminals 232Ato 232Nof the comparators 224A to 224N are more accurate, resulting in improved control loop operations. Respective comparison results are provided to respective terminals of each set of first terminals 244Ato 244N of the control logic 242Ato 242N. Each control logic 242Ato 242Ngenerates respective switch control signals at respective terminals of each set of second terminals 246Ato 246Nresponsive to the comparison results. Each driver circuitry 248Ato 248N receives respective switch control signals (at respective terminals of each set of first terminals 250Ato 250N) and provides corresponding switch drive signals (at respective terminals of each set of second terminals 252A to 252N). The switch drive signals are output from respective terminals of the set of terminals 223Ato 223Nand are provided to respective terminals of each set of second terminals 218Ato 218Nof the power stages 214A to 214Nto control respective switches of the power stages 214Ato 214N. As each load 260Ato 260Nmay vary, each controller 222A to 222Nmay control each respective power stage of the power stages 214Ato 214N differently. With the compensation circuitry 238A to 238N, comparison results are adjusted such that switching bursts are avoided during DCM operations. Use of the dynamic biasing circuitry 234A to 234Nand the compensation circuitry 238Ato 238Nwith respective comparators 224A to 224Nreduces power consumption during respective DCM operations while avoiding switching bursts to reduce VOUT ripple and improve efficiency of the power stages 214Ato 214N. The improved efficiency of the power stages 214Ato 214Nis cumulative, which provide benefits such as: reducing power consumption of the computer rack 200; reducing unwanted heat emissions; and reducing heat sink / cooling overhead for electronics of the computer rack 200.

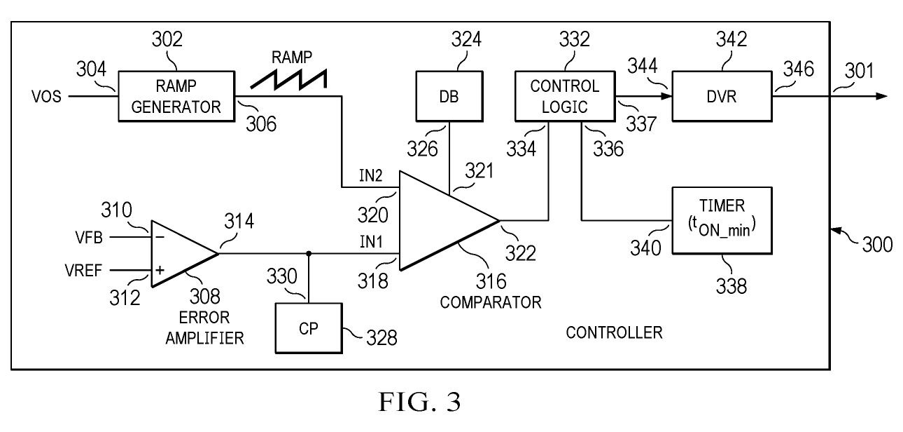

FIG. 3 is a diagram showing an example controller 300. The controller 300 of FIG. 3 is an example of each respective controller 122A to 122N in FIG. 1, or each respective controller 222A to 222N in FIG. 2. In the example of FIG. 3, the controller 300 has a set of terminals 301. The set of terminals 301 are examples of each of the terminals 123A to 123N in FIG. 1, or the terminals 223A to 223N in FIG. 2. The controller 300 includes a ramp generator 302, an error amplifier 308, a comparator 316, dynamic biasing circuitry 324, compensation circuitry 328, control logic 332, a timer 338, and driver circuitry 342. The comparator 316 is an example of each respective comparator of the comparators 124A to 124N in FIG. 1, or each respective comparator of the comparators 224A to 224N. The dynamic biasing circuitry 324 is an example of each respective dynamic biasing circuitry 134A to 134N in FIG. 1, or each respective dynamic biasing circuitry 234A to 234N in FIG. 2. The compensation circuitry 328 is an example of each respective compensation circuitry 138A to 138N in FIG. 1, or each respective compensation circuitry 238A to 238N in FIG. 2. The control logic 332 is an example of each respective control logic 142A to 142N in FIG. 1, or each respective control logic 242A to 242N in FIG. 2. The driver circuitry 342 is an example of each respective driver circuitry 148A to 148N in FIG. 1, or each respective driver circuitry 248A to 248N in FIG. 2.

The ramp generator 302 has a first terminal 304 and a second terminal 306. The error amplifier 308 has a first terminal 310, a second terminal 312, and a third terminal 314. The comparator 316 has a first terminal 318, a second terminal 320, a third terminal 321, and a fourth terminal 322. The first terminal 318 is an example of each respective first terminal 126A to 126N in FIG. 1, or each respective first terminal 226A to 226N in FIG. 2. The second terminal 320 is an example of each respective second terminal 128A to 128N in FIG. 1, or each respective second terminal 228A to 228N in FIG. 2. The third terminal 321 is an example of each respective third terminal 130A to 130N in FIG. 1, or each respective third terminal 230A to 230N in FIG. 2. The fourth terminal 322 is an example of each respective fourth terminal 132A to 132N in FIG. 1, or each respective fourth terminal 223A to 223N. The dynamic biasing circuitry 324 has a terminal 326. The terminal 326 is an example of each respective terminal 136A to 136N in FIG. 1, or each respective terminal 236A to 236N in FIG. 2. The compensation circuitry 328 has a terminal 330. The terminal 330 is an example of each respective terminal 140A to 140N in FIG. 1, or each respective terminal 240A to 240N in FIG. 2. The control logic 332 has a first terminal 334, a second terminal 336, and a set of third terminals 337. The first terminal 334 is an example of each respective first terminal 144A to 144N in FIG. 1, or each respective first terminal 244A to 244N in FIG. 2. The set of third terminals 337 are examples of each respective set of second terminals 146A to 146N in FIG. 1, or each respective set of second terminals 246A to 246N in FIG. 2. The timer 338 has a terminal 340. The driver circuitry 342 has a set of first terminals 344 and a set of second terminals 346. The set of first terminals 344 are examples of each respective set of first terminals 150A to 150N in FIG. 1, or each respective set of first terminals 250A to 250N in FIG. 2. The set of second terminals 346 are an example of each respective set of second terminals 152A to 152N in FIG. 1, or each respective set of second terminals 252A to 252N in FIG. 2.

In the example of FIG. 3, the third terminal 314 of the error amplifier 308 is coupled to the first terminal 318 of the comparator 316 and the terminal 330 of the compensation circuitry 328. The second terminal 306 of the ramp generator 302 is coupled to the second terminal 320 of the comparator 316. The third terminal 321 of the comparator 316 is coupled to the terminal 326 of the dynamic biasing circuitry 324. The fourth terminal 322 of the comparator 316 is coupled to the first terminal 334 of the control logic 332. The second terminal 336 of the control logic 332 is coupled to the terminal 340 of the timer 338. The set of third terminals 337 of the control logic 332 are coupled to respective terminals of the set of first terminals 344 of the driver circuitry 342. The set of second terminals 346 of the driver circuitry 342 are coupled to respective terminals of the set of terminals 301 of the controller 300.

In some examples, the ramp generator 302 operates to: receives an offset voltage (VOS) at the first terminal 304; and a provide a ramp signal at the second terminal 306 responsive to VOS. The ramp signal from the ramp generator represents the behavior of inductor current of a respective power stage. The error amplifier 308 operates to: receive a feedback voltage (VFB, where VFB is equal to a respective VOUT or a scaled version of the respective VOUT) at the first terminal 310; receive a reference voltage (VREF, where VREF is equal to a target VOUT) at the second terminal 312; and provide an error amplifier result at the third terminal 314 responsive to VFB and V_{REF}. In some examples, the first terminal 310 is an inverting (-) terminal and the second terminal 312 is a non-inverting (+) terminal. The comparator 316 operates to: receive the error amplifier result as a first signal (IN1) at the first terminal 318; receive the ramp signal as a second signal (IN2) at the second terminal 320; receive a biasing current from the dynamic biasing circuitry 324 at the third terminal 321; and provide comparison results at the fourth terminal 322 responsive to the signal IN1, the signal IN2, and the biasing current. In the example of FIG. 3, the compensation circuitry 328 operates to: compensate the signal IN1 to account for variance or disturbance in the signal IN1 value due to different bias currents being applied at the third terminal 321 and local capacitance (e.g., gate-source capacitance of an input pair transistor of the comparator 316). In some examples, the compensation applied by the compensation circuitry 328 reduces the amplitude of the signal IN1 to account for amplitude changes to the signal IN1 due to use of different bias currents and the local capacitance.

The timer 338 operates to provide timer results as the terminal 340 based on a predetermined on-time interval. The control logic 332 operates to: receive comparison results from the comparator 316 at the first terminal 334; receive the timer results at the second terminal 336; and provide switch control signals at the set of third terminals 337 responsive to the comparison results and the timer results. The driver circuitry 342 operates to: receive the switch control signals at the set of first terminals 344; and provide switch drive signals at the set of second terminals 346 responsive to the switch control signals. The switch driver signals are provided to the set of terminals 301 to control switches of a power stage (e.g., one of the power stages 114A to 114N in FIG. 1, or one of the power stages 214A to 214N in FIG. 2).

With the compensation circuitry 328, comparison results are adjusted such that switching bursts are avoided during DCM operations. Use of the dynamic biasing circuitry 324 and the compensation circuitry 328 with the comparator 316 reduces power consumption during respective DCM operations while avoiding switching bursts to reduce VOUT ripple and improve efficiency of a power stage controlled by the controller. When multiple controllers such as the controller 300 are used, the improved efficiency of the respective power stages is cumulative, which provide benefits such as: reducing power consumption of a vehicle (e.g., the vehicle 100 in FIG. 1) or a computer rack (e.g., the computer rack 200 in FIG. 2); extending the charge duration and life of a battery (e.g., the battery 102 in FIG. 1); reducing unwanted heat emissions by electronics of a vehicle (e.g., the vehicle 100 in FIG. 1) or a compute rack (e.g., the computer rack 200 in FIG. 2); and reducing heat sink / cooling overhead for electronics of a vehicle (e.g., the vehicle 100 in FIG. 1) or a computer rack (e.g., the computer rack 200 in FIG. 2).

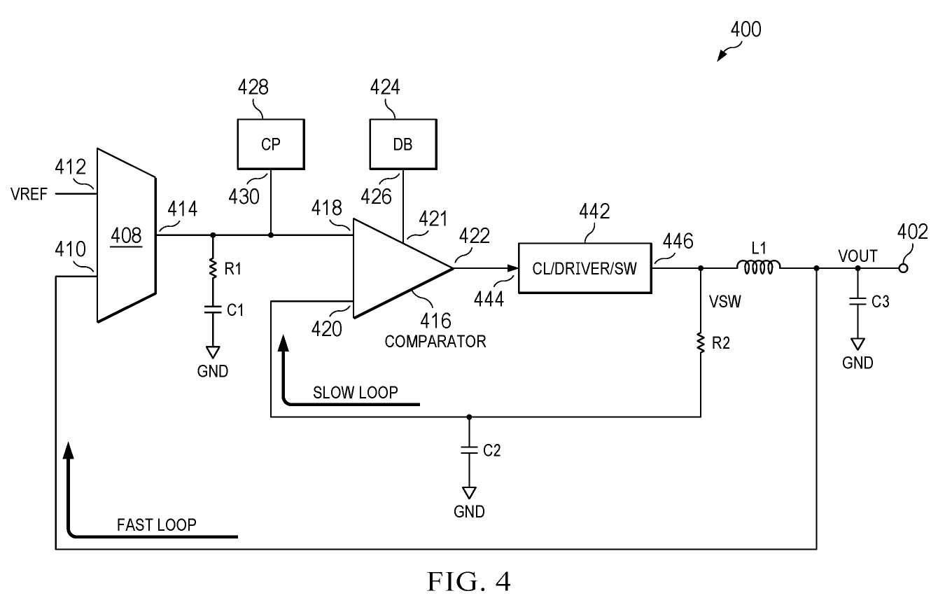

FIG. 4 is a diagram showing another example controller 400. The controller 400 is an example of each respective controller 122A to 122N in FIG. 1, or each respective controller 222A to 222N in FIG. 2. In the example of FIG. 4, the controller 400 has terminals 402. The terminals 402 are an examples of each of the terminals 123A to 123N in FIG. 1, or the terminals 223A to 223N in FIG. 2. The controller 400 includes an error amplifier 408, a comparator 416, dynamic biasing circuitry 424, compensation circuitry 428, control logic / driver circuitry / switches 442, resistors R1 and R2, capacitors C1, C2, and C3, and inductor L1. The comparator 416 is an example of each respective comparator of the comparators 124A to 124N in FIG. 1, or each respective comparator of the comparators 224A to 224N. The dynamic biasing circuitry 424 is an example of each respective dynamic biasing circuitry 134A to 134N in FIG. 1, or each respective dynamic biasing circuitry 234A to 234N in FIG. 2. The compensation circuitry 428 is an example of each respective compensation circuitry 138A to 138N in FIG. 1, or each respective compensation circuitry 238A to 238N in FIG. 2. The control logic / driver circuitry / switches 442 is an example of each respective control logic 142A to 142N, driver circuitry 148A to 148N in FIG. 1, and respective power stage switches of the power stages 114A to 114N in FIG. 1, or each respective control logic 242A to 242N, the driver circuitry 248A to 248N in FIG. 2, and respective power stage switches of the power stages 214A to 214N in FIG. 2.

The error amplifier 408 has a first terminal 410, a second terminal 412, and a third terminal 314. The comparator 416 has a first terminal 418, a second terminal 420, a third terminal 421, and a fourth terminal 422. The first terminal 418 is an example of each respective first terminal 126Ato 126N in FIG. 1, or each respective first terminal 226A to 226N in FIG. 2. The second terminal 420 is an example of each respective second terminal 128A to 128N in FIG. 1, or each respective second terminal 228A to 228N in FIG. 2. The third terminal 421 is an example of each respective third terminal 130A to 130N in FIG. 1, or each respective third terminal 230A to 230N in FIG. 2. The fourth terminal 422 is an example of each respective fourth terminal 132A to 132N in FIG. 1, or each respective fourth terminal 223A to 223N. The dynamic biasing circuitry 424 has a terminal 426. The terminal 426 is an example of each respective terminal 136A to 136N in FIG. 1, or each respective terminal 236A to 236N in FIG. 2. The compensation circuitry 428 has a terminal 430. The terminal 430 is an example of each respective terminal 140A to 140N in FIG. 1, or each respective terminal 240A to 240N in FIG. 2. The control logic / driver circuitry / switches 442 has a first terminal 444 and a second terminal 446. The first terminal 444 is an example of each respective first terminal 144A to 144N in FIG. 1, or each respective first terminal 244A to 244N in FIG. 2. The second terminal 446 is an example of a switch node between respective power stage switches of the power stages 114A to 114N in FIG. 1, or a switch node between respective power stage switches of the power stages 214A to 214N in FIG. 2. In the example of FIG. 4, each of the resistors R1 and R2, each of the capacitors C1, C2, and C3, and the inductor L1 has a respective first terminal and a respective second terminal.

In the example of FIG. 4, the first terminal 410 of the error amplifier 408 is coupled to the terminals 402 of the controller 400, the first terminal of the capacitor C3, and the second terminal of the inductor L1. The second terminal 412 of the error amplifier 408 is coupled to a VREF source (not shown). The third terminal 414 of the error amplifier 408 is coupled to the first terminal 418 of the comparator 416, the terminal 430 of the compensation circuitry 428, and the first terminal of the resistor R1. The second terminal of the resistor R1 is coupled to the first terminal of the capacitor C1. The second terminal of the capacitor C1 is coupled to ground or a ground terminal. The third terminal 421 of the comparator 416 is coupled to the terminal 426 of the dynamic biasing circuitry 424. The fourth terminal 422 of the comparator 416 is coupled to the first terminal 444 of the control logic / driver circuitry / switches 442. The second terminal 446 of the control logic / driver circuitry / switches 442 is coupled to first terminal of the resistor R2 and the first terminal of the inductor L1. The second terminal of the resistor R2 is coupled to the first terminal of the capacitor C2 and the second terminal 420 of the comparator 416. The second terminal of the capacitor C2 is coupled to ground or a ground terminal. In the example of FIG. 4, the resistor R2 and the capacitor C2 are components of a slow control loop between the second terminals 446 of the control logic / driver circuitry / switches 442 and the second terminal 420 of the comparator 416. The inductor L1 is a component of a fast control loop between the second terminals 446 of the control logic / driver circuitry / switches 442 and the first terminal 410 of the error amplifier 408.

In some examples, the error amplifier 408 operates to: receive a fast control loop results (e.g., VFB) at the first terminal 410; receive VREF at the second terminal 412; and provide an error amplifier result at the third terminal 414 responsive to VFB and VREF. In some examples, the first terminal 410 is an inverting (-) terminal and the second terminal 412 is a non-inverting (+) terminal. The comparator 416 operates to: receive the error amplifier result as a first signal at the first terminal 418; receive slow control loop results as a second signal at the second terminal 420; receive a biasing current from the dynamic biasing circuitry 424 at the third terminal 421; and provide comparison results at the fourth terminal 422 responsive to the first signal (e.g., error amplifier results), the second signal (e.g., slow control loop results), and the biasing current. In the example of FIG. 4, the compensation circuitry 428 operates to: apply a compensation to the error amplifier results to account for the effect of different bias currents being applied at the third terminal 421 and local capacitance (e.g., gate-source capacitance of an input pair transistor of the comparator 416). In some examples, the compensation circuitry 328 reduces an amplitude of the error amplifier results by providing a reverse current or charge, where the reverse current or charge accounts for amplitude changes to the error amplifier results due to dynamic biasing and the local capacitance.

The control logic / driver circuitry / switches 442 operates to: receive comparison results from the comparator 416 at the first terminal 444; control power stage switches responsive to the comparison results; and provide a switch node voltage (VSW) at the second terminal 446 responsive to the comparison results, driver circuitry operations, and power stage switch operations.

With the compensation circuitry 428, comparison results are adjusted such that switching bursts are avoided during DCM operations. Use of the dynamic biasing circuitry 424 and the compensation circuitry 428 with the comparator 416 reduces power consumption during respective DCM operations while avoiding switching bursts to reduce VOUT ripple and improve efficiency of a power stage controlled by the controller. When multiple controllers such as the controller 400 are used, the improved efficiency of the respective power stages is cumulative, which provide benefits such as: reducing power consumption of a vehicle (e.g., the vehicle 100 in FIG. 1) or a computer rack (e.g., the computer rack 200 in FIG. 2); extending the charge duration and life of a battery (e.g., the battery 102 in FIG. 1); reducing unwanted heat emissions by electronics of a vehicle (e.g., the vehicle 100 in FIG. 1) or a compute rack (e.g., the computer rack 200 in FIG. 2); and reducing heat sink / cooling overhead for electronics of a vehicle (e.g., the vehicle 100 in FIG. 1) or a computer rack (e.g., the computer rack 200 in FIG. 2).

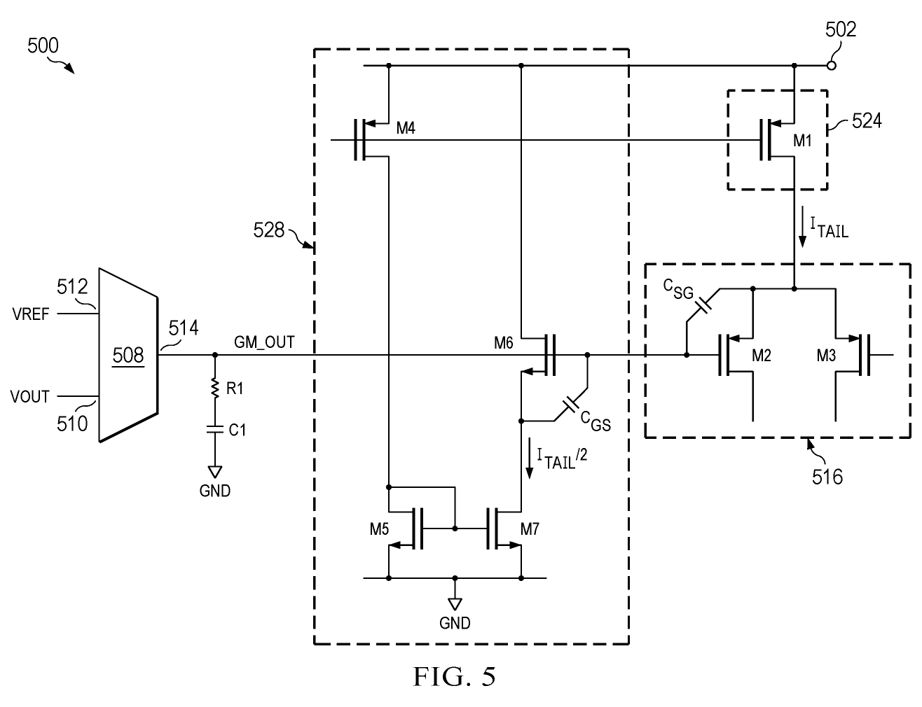

FIG. 5 is a diagram showing example controller circuitry 500. The controller circuitry 500 includes example components of each respective controller 122A to 122N in FIG. 1, each respective controller 222A to 222N in FIG. 2, the controller 300 in FIG. 3, or the controller 400 in FIG. 4. In the example of FIG. 5, the controller circuitry 500 includes an error amplifier 508, the resistor R1, the capacitor C1, comparator circuitry 516, dynamic biasing circuitry 524, and compensation circuitry 528. The error amplifier 508 is an example of the error amplifier 308 in FIG. 3, or the error amplifier 408 in FIG. 4. The dynamic biasing circuitry 524 includes an example component of each respective dynamic biasing circuitry 134A to 134N in FIG. 1, each respective dynamic biasing circuitry 234A to 234N in FIG. 2, the dynamic biasing circuitry 324 in FIG. 3, or the dynamic biasing circuitry 424 in FIG. 4. The comparator circuitry 516 includes example components of each respective comparator 124A to 124N in FIG. 1, each respective comparator 224A to 224N in FIG. 1, the comparator 316 in FIG. 3, or the comparator 416 in FIG. 4. The compensation circuitry 528 includes example components of each respective compensation circuitry 138A to 138N in FIG. 1, each respective compensation circuitry 238A to 238N in FIG. 2, the compensation circuitry 328 in FIG. 3, or the compensation circuitry 428 in FIG. 4.

In the example of FIG. 5, the dynamic biasing circuitry 524 includes a transistor M1. The comparator circuitry 516 includes transistors M2 and M3. The compensation circuitry 528 includes transistors M4 to M7. The error amplifier 508 has a first terminal 510, a second terminal 512, and a third terminal 514. Each of the transistors M1 to M7 has a first terminal, a second terminal, and a control terminal. In the example of FIG. 1, the transistors M1 to M4 are n-channel field-effect transistors (NFETs) and the transistors M5 to M7 are p-channel field-effect transistors (PFETs). In other examples, the transistors M1 to M4 are PFETs and the transistors M5 to M7 are NFETs. The controller circuitry 500 also shows capacitances C_{SG} and C_{GS}, where C_{SG} is the source-gate capacitance of the transistor M2 and C_{GS} is the gate-source capacitance of the transistor M6.

In the example of FIG. 5, the first terminal 510 of the error amplifier 508 is coupled to a VOUT source (e.g., the output terminal of a power stage). In other examples, the first terminal 510 of the error amplifier 508 is coupled to a VFB source (e.g., a voltage divider terminal between the output terminal of a power stage and the first terminal 510). The second terminal 512 of the error amplifier 508 is coupled to a VREF (or target VOUT) source. The third terminal 514 of the error amplifier 508 is coupled to the first terminal of the resistor R1 and the control terminals of the transistors M2 and M6. The second terminal of the resistor R1 is coupled to the first terminal of the capacitor C1. The second terminal of the capacitor C1 is coupled to ground or a ground terminal. The first terminals of the transistor M1 and M4 are coupled to a voltage supply terminal 502. The second terminal of the transistor M1 is coupled to the first terminals of the transistors M2 and M3 and provides a bias current (I_{TAIL}) to the comparator circuitry 516. The second terminals of the transistors M2 and M3 are coupled to other circuitry of the comparator 516. The control terminal of the transistor M3 is coupled to a ramp generator (e.g., the ramp generator 302 in FIG. 3) or a slow loop result as in FIG. 4. The control terminals of the transistor M1 and M4 are coupled to dynamic biasing circuitry, which provides: a lower current during pause intervals of DCM operations; and a higher current during CCM operations. The second terminal of the transistor M4 is coupled to the first terminal of the transistor M5 and the control terminals of the transistors M5 and M7. The second terminals of the transistors M5 and M7 are coupled to ground or a ground terminal. The first terminal of the transistor M7 is coupled to the second terminal of the transistor M6.

In the example of FIG. 5, the error amplifier 508 operates to: receive VOUT (or VFB) at the first terminal 510; VREF at the second terminal 512; and provide error amplifier results (GM_OUT) at the third terminal responsive to VOUT (or VFB) and VREF. The compensation circuitry 528 operates to adjust GM_OUT (e.g., decrease the amplitude of GM_OUT) to account for GM_OUT variance (e.g., an increase in GM_OUT amplitude) due to charge transfer from the dynamic biasing circuitry 524 via capacitances C_{SG} and C_{GS}. In some examples, the compensation circuitry 528 decreases GM_OUT to below a threshold or maintains GM_OUT within a target voltage range.

In some examples, the compensation circuitry 528 generates an opposite current/charge relative to I_{TAIL}. If the comparator circuitry 516 includes a PMOS input pair (transistors M2 and M3) as in FIG. 5, current flows out of the input pair transistor (e.g., M2 transistor) and a respective source-to-gate voltage (V_{SG}) increases. If the comparator circuitry 516 includes a NMOS input pair (replace transistors M2 and M3 with NMOS transistors), current flows into the input pair transistor (e.g., the M2 transistor replacement) and the respective V_{GS} increases. With the compensation circuitry 528, a zero net current coming into or out of the comparator input is possible (with the comparator circuitry 516 using either NMOS input pair transistors or PMOS input pair transistors). In some examples, the input pair transistors M2 and M3 and the transistor M6 have matching areas and gate-to-source capacitances so that V_{GS} is approximately the same responsive to dynamic biasing. In some examples, the compensation circuitry 528 is first-order process insensitive. Although different transistor types are used (NMOS and PMOS), the V_{GS} change and C_{GS} is similar. In some examples, the transistors M2, M3, and M6 have the same gate oxide thickness.

With the compensation circuitry 528, comparison results are adjusted such that switching bursts are avoided during DCM operations. Use of the dynamic biasing circuitry 524 and the compensation circuitry 528 with the comparator 516 reduces power consumption during respective DCM operations while avoiding switching bursts to reduce VOUT ripple and improve efficiency of a power stage controlled by the controller. When multiple controllers with the controller circuitry 500 are used, the improved efficiency of the respective power stages is cumulative, which provide benefits such as: reducing power consumption of a vehicle (e.g., the vehicle 100 in FIG. 1) or a computer rack (e.g., the computer rack 200 in FIG. 2); extending the charge duration and life of a battery (e.g., the battery 102 in FIG. 1); reducing unwanted heat emissions by electronics of a vehicle (e.g., the vehicle 100 in FIG. 1) or a compute rack (e.g., the computer rack 200 in FIG. 2); and reducing heat sink / cooling overhead for electronics of a vehicle (e.g., the vehicle 100 in FIG. 1) or a computer rack (e.g., the computer rack 200 in FIG. 2).

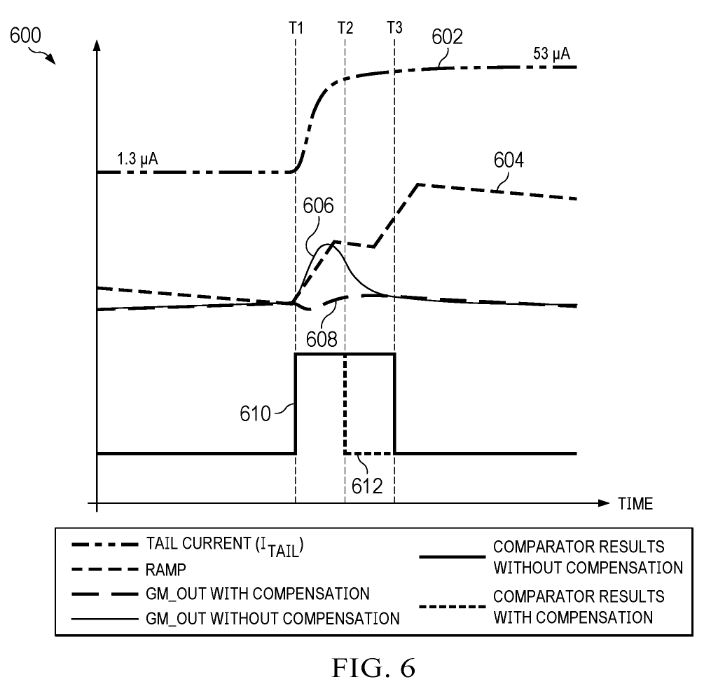

FIG. 6 is a timing diagram 600 showing example waveforms of a controller (e.g., each respective controller 122A to 122N in FIG. 1, each respective controller 222A to 222N in FIG. 2, the controller 300 in FIG. 3, the controller 400 in FIG. 4, or the controller circuitry 500 in FIG. 5). More specifically, the timing diagram 600 includes example waveforms during a pause interval of DCM operations as described herein. The example waveforms includes ITAIL 602, ramp 604, a first GM_OUT 606 (without compensation), a second GM_OUT 608 (with compensation), first comparator results 610 (without compensation), and second comparator results 612 (with compensation).

As shown in FIG. 6, I_{TAIL} has a first value (e.g., 1.3uA) before time T1 (e.g., due to dynamic biasing circuitry providing a low quiescent current during a DCM pause interval). At time T1, the first and second comparator results 610 and 612 are asserted indicating VOUT or VFB has dropped below VREF or a target VOUT. In response, I_{TAIL} begins to increase (e.g., due to dynamic biasing circuitry increasing from the low quiescent current to a higher current when a DCM pulse or transition to CCM is needed). Without compensation, the first GM_OUT 606 increases due to dynamic biasing (the increase in I_{TAIL} after time T1) and local capacitance as described herein. With the first GM_OUT 606, the first comparator results 610 are asserted until time T3, and a switching burst occurs as indicated by consecutive positive slopes in the ramp 604. With compensation, the second GM_OUT 608 is not affected by the increase in I_{TAIL} after time T1. With the second GM_OUT 608, the second comparator results 612 are de-asserted at time T2, and a switching burst of power stage switches is avoided.

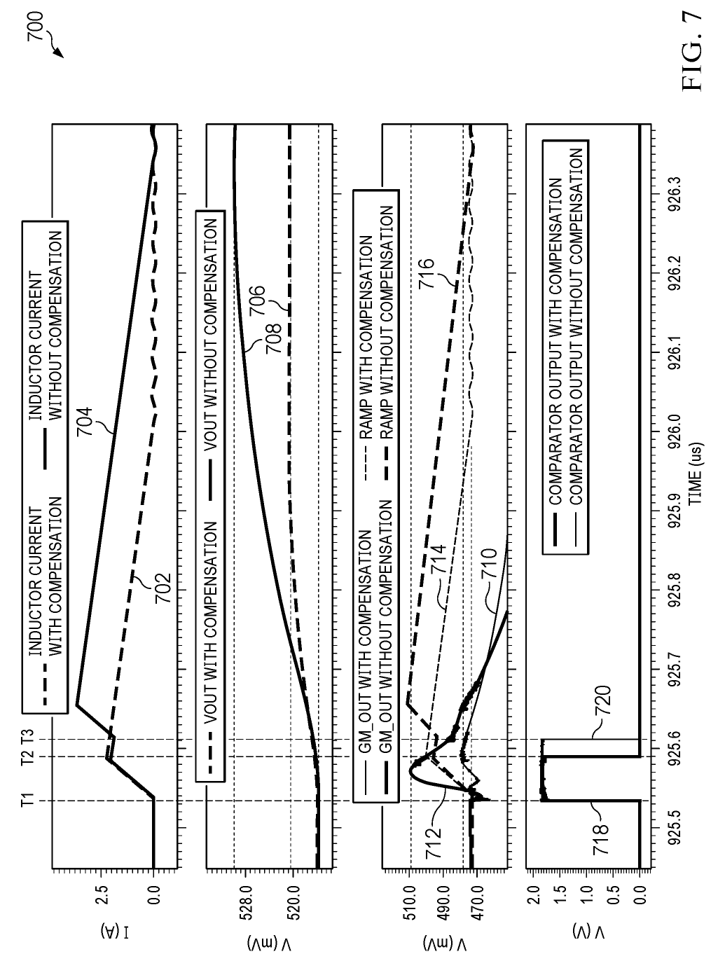

FIG. 7 is a timing diagram 700 showing example waveforms of a power stage and controller (e.g., each respective controller 122A to 122N in FIG. 1, each respective controller 222A to 222N in FIG. 2, the controller 300 in FIG. 3, the controller 400 in FIG. 4, or the controller circuitry 500 in FIG. 5). More specifically, the timing diagram 700 includes example waveforms during a pause interval of DCM operations as described herein. The example waveforms includes first inductor current 702 (with compensation), second inductor current 704 (without compensation), first VOUT 706 (with compensation), second VOUT 708 (without compensation), first GM_OUT 710 (with compensation), second GM_OUT 712 (without compensation, first ramp 714 (with compensation), second ramp 716 (without compensation), first comparator results 718 (with compensation), and second comparator results 720 (without compensation).

At time T1, the first and second comparator results 718 and 720 are asserted indicating VOUT or VFB has dropped below VREF or a target VOUT. In response, I_{TAIL} (see e.g., I_{TAIL} in FIG. 6) begins to increase (e.g., due to dynamic biasing circuitry increasing from the low quiescent current to a higher current when a DCM pulse or transition to CCM is needed). Without compensation, the first GM_OUT 712 increases due to dynamic biasing (the increase in I_{TAIL} after time T1). With the first GM_OUT 712, the second comparator results 720 stay asserted until time T3, and a switching burst occurs as indicated by the second inductor current 704 and second ramp 716 being multi-tier (up-down up-down and then settling). With compensation, the first GM_OUT 710 is not affected by the increase in I_{TAIL} after time T1. With the first GM_OUT 710, the first comparator results 718 is de-asserted at time T2, and a switching burst of power stage switches is avoided as indicated by the first inductor current 702 and the first ramp 714 being single-tier (up-down and then settling).

In some examples, a system (e.g., the vehicle 100 in FIG. 1, the computer rack 200 in FIG. 2, or other system) includes: a load (e.g., one of the loads 160A to 160N in FIG. 1, or one of the loads 260A to 260N in FIG. 2); a circuit (e.g., one of the power stages 114A to 114N in FIG. 1, or one of the power stages 214A to 214N in FIG. 2) having switches, the power stage coupled to the load; and a controller (e.g., one of the controllers 122A to 122N in FIG. 1, one of the controllers 222A to 222N in FIG. 2, the controller 300 in FIG. 3, the controller 400 in FIG. 4, or the controller circuitry 500 in FIG. 5) coupled to the circuit. In such examples, the controller includes a comparator (e.g., one of the comparators 124A to 124N in FIG. 1, one of the comparators 224A to 224N in FIG. 2, the comparator 316 in FIG. 3, the comparator 416 in FIG. 4) having a first terminal (e.g., one of the first terminals 126A to 126N in FIG. 1, one of the first terminals 226A to 226N in FIG. 2, the first terminal 318 in FIG. 3, or the first terminal 418 in FIG. 4), a second terminal (e.g., one of the second terminals 128A to 128N in FIG. 1, one of the second terminals 228A to 228N in FIG. 2, the second terminal 320 in FIG. 3, or the second terminal 420 in FIG. 4), a third terminal (e.g., one of the third terminals 130A to 130N, one of the third terminals 230A to 230N, the third terminal 321 in FIG. 3, or the third terminal 421 in FIG. 4), and a fourth terminal (e.g., one of the fourth terminals 132A to 132N in FIG. 1, one of the fourth terminals 232A to 232N in FIG. 2, the fourth terminal 322 in FIG. 3, or the fourth terminal 422 in FIG. 4).

In such examples, the controller is configurable to: receive a first current (a first bias current or I_{TAIL} value herein) at the third terminal (e.g., the third terminal 130Ato 130N in FIG. 1, the third terminal 230A to 230Nin FIG. 2, the third terminal 321 in FIG. 3, the third terminal 421 in FIG. 4, or the first terminals of the transistors M2 and M3 in FIG. 5) of the comparator; receive a second current (e.g., a second bias current or I_{TAIL} value herein) at the third terminal of the comparator responsive to entering a pause mode in which the switches are turned off, the second current less than the first current; receive a first signal (e.g., one of signals IN1_A to IN1_N in FIGS. 1 or 2, or the signal IN1 in FIG. 3) at the first terminal (e.g., one of the first terminals 126A to 126Nin FIG. 1, one of the first terminals 226A to 226N in FIG. 2, the first terminal 318 in FIG. 3, the first terminal 418 in FIG. 4, or the control terminal of the transistor M2 in FIG. 5) of the comparator during the pause mode; apply a compensation to the first signal resulting in a compensated first signal (e.g., the second GM_OUT in FIG. 6, or the first GM_OUT 710 in FIG. 7), the compensated first signal having a lower amplifier than the first signal; receive a second signal (e.g., one of signals IN2_A to IN2_N in FIGS. 1 or 2, or the signal IN2 in FIG. 3) at the second terminal (e.g., one of the second terminals 128A to 128N in FIG. 1, one of the second terminals 228Ato 228Nin FIG. 2, the second terminal 320 in FIG. 3, the second terminal 420 in FIG. 4, or the control terminal of the transistor M3 in FIG. 5) of the comparator; provide comparator results at the fourth terminal (e.g., one of the fourth terminals 132A to 132Nin FIG. 1, one of the fourth terminals 232Ato 232N in FIG. 2, the fourth terminal 322 in FIG. 3, or the fourth terminal 422 in FIG. 4) of the comparator responsive to the compensated first signal and the second signal; and, responsive to the comparator results, provide control signals for the switches. In some examples, the control signals for the switches result in high-side on intervals separated by pause intervals. With the compensated first signal and related comparator results, the control signals for the switches avoid switching bursts in which consecutive high-side on intervals occur without a pause interval.

In some examples, the load is a first load, the circuit is a first circuit, the controller is a first controller, the switches are first switches, the comparator is a first comparator, the compensation is a first compensation, the comparator results are first comparator results, and the system also includes: a second load; a second circuit (e.g., a second power stage herein) having second switches, the second circuit coupled to the second load; and a second controller coupled to the second circuit. The second controller (e.g., another of the controllers 122Ato 122N in FIG. 1, another of the controllers 222Ato 222N in FIG. 2, another controller 300 in FIG. 3, another controller 400 in FIG. 4, or another controller circuitry 500 in FIG. 5) includes a second comparator having a first terminal, a second terminal, a third terminal, and a fourth terminal.

In some examples, the second controller is configurable to: receive a third current (e.g., a first bias current or I_{TAIL} value for a second comparator) at the third terminal (e.g., another third terminal 130Ato 130Nin FIG. 1, another third terminal 230Ato 230N in FIG. 2, another third terminal 321 in FIG. 3, another third terminal 421 in FIG. 4, or another first terminals of the transistors M2 and M3 in FIG. 5) of the second comparator; receive a fourth current (e.g., a second bias current or I_{TAIL} value for the second comparator) at the third terminal of the second comparator responsive to entering a pause mode in which the second switches are turned off, the fourth current less than the third current; receive a third signal (e.g., another of the signals IN1_A to IN1_N in FIGS. 1 or 2, another signal IN1 in FIG. 3) at the first terminal (e.g., another of the first terminals 126Ato 126Nin FIG. 1, another of the first terminals 226Ato 226Nin FIG. 2, another first terminal 318 in FIG. 3, another first terminal 418 in FIG. 4, or the control terminal of another transistor M2 in FIG. 5) of the second comparator during the pause mode; apply a second compensation to the third voltage resulting in a compensated third signal (e.g., another second GM_OUT in FIG. 6, or another first GM_OUT 710 in FIG. 7), the compensated third signal having a lower amplitude than the third signal; receive a fourth signal (e.g., one of signals IN2_A to IN2_N in FIGS. 1 or 2, or the signal IN2 in FIG. 3) at the second terminal (e.g., another of the second terminals 128Ato 128Nin FIG. 1, another of the second terminals 228A to 228N in FIG. 2, another second terminal 320 in FIG. 3, another second terminal 420 in FIG. 4, or the control terminal of another transistor M3 in FIG. 5) of the second comparator; provide second comparator results responsive to the compensated third signal and the fourth signal; and, responsive to the second comparator results, provide control signals for the second switches. In some examples, the control signals for the second switches result in high-side on intervals separated by pause intervals. With the compensated third signal and related second comparator results, the control signals for the second switches avoid switching bursts in which consecutive high-side on intervals occur without a pause interval.

In some examples, the system is a computer rack (e.g., the computer rack 200 in FIG. 2), and the first load and the second load are processors. In some examples, the system is a vehicle (e.g., the vehicle 100 in FIG. 1), and the first load and the second load are processors.

In some examples, the controller includes a first control loop (e.g., the error amplifier 408, the first terminal 418 of the comparator 416, and the inductor L1) and a second control loop (e.g., the second terminal 420 of the comparator 416, the resistor R2, and the capacitor C2 in FIG. 4), the second control loop slower than the first control loop, a first terminal (e.g., the first terminal 418) of the comparator coupled to the first control loop, and a second terminal (e.g., the second terminal 420) of the comparator coupled to the second control loop.

In some examples, the controller is configurable to apply the compensation by generating a negative current or charge to counter an increase in amplitude in the first signal due to dynamic biasing. In some examples, the comparator includes NMOS input pair transistors (e.g., replace transistor M2 and M3 with NMOS transistors), and the compensation is performed by compensation circuitry that include a PMOS transistor (replace the transistor M6 with a PMOS transistor). The NMOS input pair transistors and the PMOS transistor of the compensation circuitry have approximately the same gate-source capacitances and gate oxide thickness.

In some examples, the comparator includes PMOS input pair transistors (e.g., the transistors M2 and M3 in FIG. 5), and the compensation is performed by compensation circuitry that includes an NMOS transistor (e.g., the transistors M6 in FIG. 5). In some examples, the PMOS input pair transistors (e.g., the transistors M2 and M3 in FIG. 5) and the NMOS transistor (e.g., the transistor M6 in FIG. 5) of the compensation circuitry have approximately the same gate-source capacitances and gate oxide thickness.

In some examples, a circuit (e.g., a comparator, an LDO, or other circuit with input pair transistors and higher/lower power mode options) includes: a first transistor (e.g., the transistor M2 in FIG. 5) having a first terminal, a second terminal, and a control terminal; a second transistor (e.g., the transistor M3 in FIG. 5) having a first terminal, a second terminal, and a control terminal, the first and second transistors forming an input pair; dynamic biasing circuitry (e.g., the dynamic biasing circuitry 524 in FIG. 5) including a third transistor (e.g., the transistor M1 in FIG. 5) having a first terminal, a second terminal, and a control terminal, the second terminal of the third transistor coupled to the first terminals of the first transistor and the second transistor; and compensation circuitry (e.g., the compensation circuitry 528 in FIG. 5) coupled to the control terminal of the first transistor. The compensation circuitry is configurable to apply a compensation to a signal at the control terminal of the first transistor. The compensation reduces an amplitude of the signal.

In some examples, the compensation circuitry includes: a fourth transistor (e.g., the transistor M6 in FIG. 5) having a first terminal, a second terminal, and a control terminal, the control terminal of the fourth transistor coupled to the control terminal of the first transistor; a fifth transistor (e.g., the transistor M7 in FIG. 5) having a first terminal, a second terminal, and a control terminal, the first terminal of the fifth transistor coupled to the second terminal of the fourth transistor; a sixth transistor (e.g., the transistor M5 in FIG. 5) having a first terminal, a second terminal, and a control terminal, the second terminal of the sixth transistor coupled to the second terminal of the fifth transistor; and a seventh transistor (e.g., the transistor M4 in FIG. 5) having a first terminal, a second terminal, and a control terminal, the first terminal of the seventh transistor coupled to the first terminal of the fourth transistor and the first terminal of the third transistor, the second terminal of the seventh transistor coupled to the first terminal of the sixth transistor and the control terminals of the fourth transistor and the fifth transistor.

In some examples, the first, second, and seventh transistors are NMOS transistors, and the fourth, fifth, and sixth transistors are PMOS transistors. In some examples, the first, second, and seventh transistors are PMOS transistors, and the fourth, fifth, and sixth transistors are NMOS transistors. In some examples, the first, second, and fourth transistors have approximately the same gate-source capacitance and gate oxide thickness.

In some examples, a circuit (e.g., one of the controller 122A to 122N in FIG. 1, one of the controllers 222A to 222N in FIG. 2, the controller 300 in FIG. 3, the controller 400 in FIG. 4, or the controller circuitry 500 in FIG. 5) incudes: an error amplifier (e.g., the error amplifier 308 in FIG. 3, the error amplifier 408 in FIG. 4, or the error amplifier 508 in FIG. 5) have a first terminal, a second terminal, and a third terminal; a comparator (e.g., one of the comparators 124A to 124N in FIG. 1, one of the comparators 224A to 224N in FIG. 2, the comparator 316 in FIG. 3, or the comparator 416 in FIG. 4) having a first terminal, a second terminal, a third terminal, and a fourth terminal, the second terminal of the comparator coupled to the third terminal of the error amplifier; dynamic biasing circuitry (e.g., one of the dynamic biasing circuitry 134A to 134N in FIG. 1, one of the dynamic biasing circuitry 234A to 234N in FIG. 2, the dynamic biasing circuitry 324 in FIG. 3, or the dynamic biasing circuitry 424 in FIG. 4) coupled to the third terminal of the comparator; and compensation circuitry (e.g., one of the compensation circuitry 138A to 138N in FIG. 1, one of the compensation circuitry 238A to 238N in FIG. 2, the compensation circuitry 328 in FIG. 3, or the compensation circuitry 428 in FIG. 4) coupled to the first terminal of the comparator and configurable to apply a compensation to a signal at the control terminal of the first transistor.

In some examples, the signal is first signal, and the comparator is configurable to: receive a first current from the dynamic biasing circuitry at the third terminal of the comparator; receive a second current from the dynamic biasing circuitry at the third terminal of the comparator responsive to a pause mode, the second current less than the first current; receive the first signal at the first terminal of the comparator during the pause mode; apply a compensation to the first signal using the compensation circuitry, the compensation resulting in a compensated first signal, the compensated first signal having a lower amplitude than the first signal; receive a second signal at the second terminal of the comparator; and provide comparator results at the fourth terminal of the comparator responsive to the compensated first signal and the second signal.

In some examples, the circuit also includes control logic and driver circuitry (e.g., control logic and driver circuitry options in FIGS. 1 to 4) having a first terminal and a second terminal, the first terminal of the control logic and driver circuitry coupled to the fourth terminal of the comparator; an inductor (e.g., the inductor L1 in FIG. 5 or respective inductors of the power stages in FIGS. 1 and 2) having a first terminal and a second terminal, the first terminal of the inductor coupled to the second terminal of the control logic and driver circuitry, and the second terminal of the inductor coupled to the third terminal of the comparator.

In some examples, the comparator includes: a first transistor (e.g., the transistor M2 in FIG. 5) having a first terminal, a second terminal, and a control terminal; and a second transistor (e.g., the transistor MM in FIG. 5) having a first terminal, a second terminal, and a control terminal, the first and second transistors forming an input pair. The dynamic biasing circuitry includes a third transistor (e.g., the transistor M1 in FIG. 5) having a first terminal, a second terminal, and a control terminal. The second terminal of the third transistor coupled to the first terminals of the first and second transistors. The compensation circuitry includes: a fourth transistor (e.g., the transistor M6 in FIG. 5); a fifth transistor (e.g., the transistor M7 in FIG. 6); a sixth transistor (e.g., the transistor M5 in FIG. 5); and a seventh transistor (e.g., the transistor M4 in FIG. 5). The fourth transistor has a first terminal, a second terminal, and a control terminal. The control terminal of the fourth transistor is coupled to the control terminal of the first transistor. The fifth transistor has a first terminal, a second terminal, and a control terminal. The first terminal of the fifth transistor is coupled to the second terminal of the fourth transistor. The sixth transistor has a first terminal, a second terminal, and a control terminal. The second terminal of the sixth transistor is coupled to the second terminal of the fifth transistor. The seventh transistor has a first terminal, a second terminal, and a control terminal. The first terminal of the seventh transistor is coupled to the first terminal of the fourth transistor and the first terminal of the third transistor. The second terminal of the seventh transistor is coupled to the first terminal of the sixth transistor and the control terminals of the fourth transistor and the fifth transistor. In some examples, the first, second, and fourth transistors have approximately the same gate-source capacitance and gate oxide thickness.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device “configured to” or “configurable to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component and/or a conductor.

A circuit or device described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field-effect transistor (“FET”) such as an NFET or a PFET, a bipolar junction transistor (BJT – e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor’s control terminal and its first and second terminals. In the context of a FET, the control terminal is the gate, and the first and second terminals are the drain and source. In the context of a BJT, the control terminal is the base, and the first and second terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor’s body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/- 10 percent of that parameter or, if the parameter is zero, a reasonable range of values around zero.

Modifications are possible in the described examples, and other examples are possible, within the scope of the claims.

What is claimed is:

1. A system comprising:
a load;
a circuit having switches, the circuit coupled to the load; and
a controller coupled to the circuit, the controller including a comparator having a first terminal, a second terminal, a third terminal, and a fourth terminal, and the controller configurable to:
receive a first current at the third terminal of a comparator;
receive a second current at the third terminal of the comparator responsive to entering a pause mode in which the switches are turned off, the second current less than the first current;
receive a first signal at the first terminal of the comparator during the pause mode;
apply a compensation to the first signal resulting in a compensated first signal, the compensated first signal having a lower amplitude than the first signal;
receive a second signal at the second terminal of the comparator;
provide comparison results at the fourth terminal of the comparator responsive to the compensated first signal and the second signal; and
responsive to the comparator results, provide control signals for the switches.

2. The system of claim 1, wherein the load is a first load, the circuit is a first circuit, the controller is a first controller, the switches are first switches, the comparator is a first comparator, the compensation is a first compensation, the comparison results are first comparison results, and the system further comprises:
a second load;
a second circuit having second switches, the second circuit coupled to the second load; and
a second controller coupled to the second circuit, the second controller including a second comparator having a first terminal, a second terminal, a third terminal, and a fourth terminal, and the second controller configurable to:
receive a third current at the third terminal of the second comparator;
receive a fourth current at the third terminal of the second comparator responsive to entering a pause mode in which the second switches are turned off, the fourth current less than the third current;
receive a third signal at the first terminal of the second comparator during the pause mode;
apply a second compensation to the third signal resulting in a compensated third signal, the compensated third signal having a lower amplitude than the third signal;
receive a fourth signal at the second terminal of the second comparator;
provide second comparison results at the fourth terminal of the comparator responsive to the compensated third signal and the fourth signal; and
responsive to the second comparison results, provide control signals for the second switches.

3. The system of claim 2, wherein the system is a computer rack, and the first load and the second load are processors.

4. The system of claim 2, wherein the system is a vehicle, and the first load and the second load are processors.

5. The system of claim 1, wherein the controller includes a first control loop and a second control loop, the second control loop is slower than the first control loop, the first terminal of the comparator coupled to the first control loop, and the second terminal of the comparator coupled to the second control loop.

6. The system of claim 1, wherein the controller is configurable to apply the compensation by generating a negative current or charge to counter an increase in amplitude in the first signal due to dynamic biasing.

7. The system of claim 1, wherein the comparator includes n-channel metal-oxide semiconductor (NMOS) input pair transistors, and the compensation is performed by a compensation circuitry that includes a p-channel metal-oxide semiconductor (PMOS) transistor.

8. The system of claim 7, wherein the NMOS input pair transistors of the comparator and the PMOS transistor of the compensation circuitry have approximately the same gate-source capacitances and gate oxide thickness.

9. The system of claim 1, wherein the comparator includes p-channel metal-oxide semiconductor (PMOS) input pair transistors, and the compensation is performed by a compensation circuitry that includes an n-channel metal-oxide semiconductor (NMOS) transistor.

10. The system of claim 9, wherein the PMOS input pair transistors of the comparator and the NMOS transistor of the compensation circuitry have approximately the same gate-source capacitances and gate oxide thickness.

11. A circuit comprising:
a first transistor having a first terminal, a second terminal, and a control terminal;
a second transistor having a first terminal, a second terminal, and a control terminal, the first and second transistors forming input pair transistors;
dynamic biasing circuitry including a third transistor having a first terminal, a second terminal, and a control terminal, the second terminal of the third transistor coupled to the first terminals of the first transistor and the second transistor; and
compensation circuitry coupled to the control terminal of the first transistor, the compensation circuitry configurable to apply a compensation to a signal at the control terminal of the first transistor, the compensation reducing an amplitude of the signal.

12. The circuit of claim 11, wherein the compensation circuitry includes:
a fourth transistor having a first terminal, a second terminal, and a control terminal, the control terminal of the fourth transistor coupled to the control terminal of the first transistor;
a fifth transistor having a first terminal, a second terminal, and a control terminal, the first terminal of the fifth transistor coupled to the second terminal of the fourth transistor;
a sixth transistor having a first terminal, a second terminal, and a control terminal, the second terminal of the sixth transistor coupled to the second terminal of the fifth transistor; and
a seventh transistor having a first terminal, a second terminal, and a control terminal, the first terminal of the seventh transistor coupled to the first terminal of the fourth transistor and the first terminal of the third transistor, the second terminal of the seventh transistor coupled to the first terminal of the sixth transistor and the control terminals of the fourth transistor and the fifth transistor.

13. The circuit of claim 12, wherein the first, second, and seventh transistors are n-channel metal-oxide semiconductor (NMOS) transistors, and the fourth, fifth, and sixth transistors are p-channel metal-oxide semiconductor (PMOS) transistors.

14. The circuit of claim 12, wherein the first, second, and seventh transistors are p-channel metal-oxide semiconductor (PMOS) transistors, and the fourth, fifth, and sixth transistors are n-channel metal-oxide semiconductor (NMOS) transistors.

15. The circuit of claim 12, wherein the first, second, and fourth transistors have approximately the same gate-source capacitance and gate oxide thickness.

16. A circuit comprising:
an error amplifier have a first terminal, a second terminal, and a third terminal;
a comparator having a first terminal, a second terminal, a third terminal, and a fourth terminal, the second terminal of the comparator coupled to the third terminal of the error amplifier;
dynamic biasing circuitry coupled to the third terminal of the comparator; and
compensation circuitry coupled to the first terminal of the comparator and configurable to apply a compensation to a signal at the first terminal of the comparator.

17. The circuit of claim 16, wherein the signal is a first signal, and the comparator is configured to:
receive a first current from the dynamic biasing circuitry at the third terminal of the comparator;
receive a second current from the dynamic biasing circuitry at the third terminal of the comparator responsive to a pause mode, the second current less than the first current;
receive the first signal at the first terminal of the comparator during the pause mode;
apply a compensation to the first signal using the compensation circuitry, the compensation resulting in a compensated first signal, the compensated first signal having a lower amplitude than the first signal;
receive a second signal at the second terminal of the comparator; and
provide comparison results at the fourth terminal of the comparator responsive to the compensated first signal and the second signal.

18. The circuit of claim 16, further comprising;
control logic and driver circuitry having a first terminal and a second terminal, the first terminal of the control logic and driver circuitry coupled to the fourth terminal of the comparator; and
an inductor having a first terminal and a second terminal, the first terminal of the inductor coupled to the second terminal of the control logic and driver circuitry, and the second terminal of the inductor coupled to the third terminal of the comparator.

19. The circuit of claim 16,
wherein the comparator includes:
a first transistor having a first terminal, a second terminal, and a control terminal; and
a second transistor having a first terminal, a second terminal, and a control terminal, the first and second transistors forming an input pair transistors,
the dynamic biasing circuitry includes a third transistor having a first terminal, a second terminal, and a control terminal, the second terminal of the third transistor coupled to the first terminals of the first and second transistors, and
the compensation circuitry includes:
a fourth transistor having a first terminal, a second terminal, and a control terminal, the control terminal of the fourth transistor coupled to the control terminal of the first transistor;
a fifth transistor having a first terminal, a second terminal, and a control terminal, the first terminal of the fifth transistor coupled to the second terminal of the fourth transistor;
a sixth transistor having a first terminal, a second terminal, and a control terminal, the second terminal of the sixth transistor coupled to the second terminal of the fifth transistor; and
a seventh transistor having a first terminal, a second terminal, and a control terminal, the first terminal of the seventh transistor coupled to the first terminal of the fourth transistor and the first terminal of the third transistor, the second terminal of the seventh transistor coupled to the first terminal of the sixth transistor and the control terminals of the fourth transistor and the fifth transistor.

20. The circuit of claim 19, wherein the first, second, and fourth transistors have approximately the same gate-source capacitance and gate oxide thickness.
